(19) United States
(12) Patent Application Publication
(10) Pub. No.: US 2010/0251192 A1
(43) Pub. Date: Sep. 30, 2010

(54) CIRCUIT DESCRIPTION GENERATING APPARATUS AND FUNCTION VERIFICATION METHOD

(75) Inventor: Takeo Nishide, Kawasaki-Shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/563,891

(22) Filed: Sep. 21, 2009

(30) Foreign Application Priority Data
Mar. 27, 2009 (JP) 2009-78492

(51) Int. Cl. G06F 17/50

(52) U.S. Cl. 716/5

(57) ABSTRACT

A circuit description generating apparatus has an ID addition part configured to add a common ID to a command inputted to a verification target circuit described by a circuit description language and data corresponding to the command, a bit width adjusting part configured to adjust a bit width of an ID of the command and an ID of the data along a signal path which pass through inside of the verification target circuit, and a circuit description generating part configured to generate a circuit description corresponding to the verification target circuit, the circuit description including the command and data with the IDs of which bit widths are adjusted by the bit width adjusting part.

### CROSS REFERENCE TO RELATED APPLICATIONS

This application is based upon and claims the benefit of priority from the prior Japanese Patent Application No. 2009-78492, filed on Mar. 27, 2009, the entire contents of which are incorporated herein by reference.

### BACKGROUND OF THE INVENTION

1. Field of the Invention

The present invention relates to a circuit description generating apparatus and a function verification method which verify functions of a verification target circuit described by a circuit description language.

2. Related Art

Recently, circuits for transmit data at high speed have been required increasingly. There have been various proposals of protocols and interfaces corresponding to these types of circuits. There has been increasingly used a data transmission circuit which transmits data at high speed between circuit blocks in a system LSI.

As one manner for verifying this type of data transmission circuit at high speed, a waveform viewer is widespread. For example, internal signals are successively dumped (outputted) during simulation or emulation, and the internal signals are inputted to the waveform viewer after the simulation or emulation in order to monitor signal waveform.

In conventional protocols, timings of commands coincide with timing of data. Therefore, it does not take so much time to trace data by the waveform viewer, and there is no likelihood in which commands are erroneously associated with data. However, some recent protocols transmit commands and data at separate timings in order to transmit them at high speed. In this case, since transition timings of commands and data do not coincide, it would never be easy to associate commands with data by using the waveform viewer. Therefore, when one data does not coincide with an expected value, it takes much time to identify the cause.

JP-A No. 2006-221474 (Kokai) discloses a technique in which when sequences of transactions are changed on a bus, information relating to the changed transaction is attached to the transaction as attribute information.

However, the above document does not assume at all that signals are branched out or consolidated inside of the verification target circuit. Therefore, it would be difficult to accurately trace signal paths inside of the verification target circuit, thereby deteriorating traceability.

### SUMMARY OF THE INVENTION

According to one aspect of the present invention, a circuit description generating apparatus, comprising:

an ID addition part configured to add a common ID to a command inputted to a verification target circuit described by a circuit description language and data corresponding to the command;

a bit width adjusting part configured to adjust a bit width of an ID of the command and an ID of the data along a signal path which pass through inside of the verification target circuit; and

a circuit description generating part configured to generate a circuit description corresponding to the verification target circuit, the circuit description including the command and data with the IDs of which bit widths are adjusted by the bit width adjusting part.

According to the other aspect of the present invention, a function verification method, comprising:

adding a common ID to a command inputted to a verification target circuit described by a circuit description language and data corresponding to the command;

adjusting a bit width of an ID of the command and an ID of the data along a signal path which pass through inside of the verification target circuit; and

generating a circuit description corresponding to the verification target circuit, the circuit description including the command and data with the IDs of which bit widths are adjusted by the adjusting.

### BRIEF DESCRIPTION OF THE DRAWINGS

FIG. 1 is a block diagram showing schematic configuration of a circuit function verification system having a circuit description generating apparatus according to one embodiment of the present invention;

FIG. 2 is a block diagram for explaining the DUT 5;

FIG. 3 is a block diagram showing characteristic constituents included in a circuit description 10 generated by the circuit description generating apparatus 1;

FIG. 4 is a diagram schematically explaining a relationship between the command ID path part 11, the write ID path part 12, the read data ID path part 13 and the DUT 5;

FIG. 5 is a flowchart showing one example of the processing procedure of the ID path parts 11 to 13;

FIG. 6 is a flowchart showing one example of detailed processing procedure of the bit width adjusting process of step S5 in FIG. 5; and

FIG. 7 is a waveform chart showing one example of results processed by the circuit description generating apparatus 1.

### DETAILED DESCRIPTION OF THE INVENTION

Embodiments according to the present invention will now be explained with reference to the accompanying drawings.

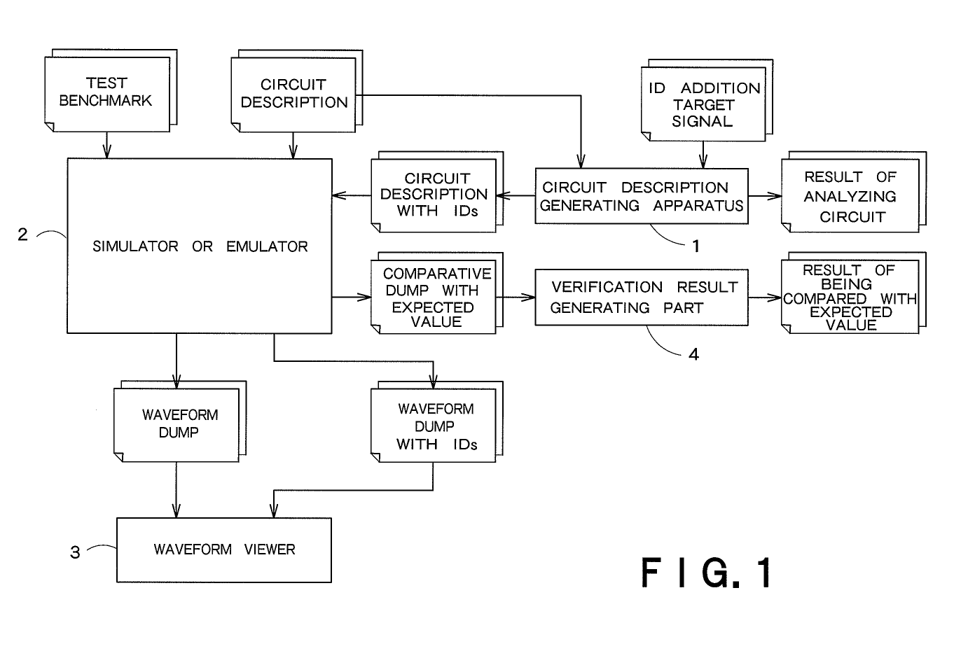

FIG. 1 is a block diagram showing schematic configuration of a circuit function verification system having a circuit description generating apparatus according to one embodiment of the present invention. The circuit function verification system in FIG. 1 has a circuit description generating apparatus 1, a simulator or emulator 2, a waveform viewer 3 and a verification result generating part 4.

The circuit description generating apparatus 1 generates circuit description obtained by describing a verification target (hereinafter called a “DUT”: Design Under Test) by using a circuit description language. The circuit description generating apparatus 1 adds IDs (identification signals) to the circuit description. The IDs correspond to input/output signals of the DUT and intermediate signals inside of the DUT, respectively. Hereinafter, the circuit description adding the IDs is called a “circuit description with IDs”. The circuit description generating apparatus 1 gives the same ID with regard to the corresponding command and data inputted to the DUT.

The circuit description and the circuit description with IDs are obtained by describing the DUT by using the circuit description language such as an HDL (Hardware Description Language). The circuit description and the circuit descriptions with IDs are applied to the simulator or emulator 2 to conduct simulation or emulation. Input data applied to the simulator or emulator 2 is an expected value. The expected value is compared with a result (measured value) obtained by the simulation or emulation to generate a dump list. The dump list is inputted to the verification result generating part 4.

The timing information obtained by the simulation or emulation is inputted to the waveform viewer 3 in a form of a waveform dump. The waveform viewer 3 displays a certain signal waveform based on the waveform dump.

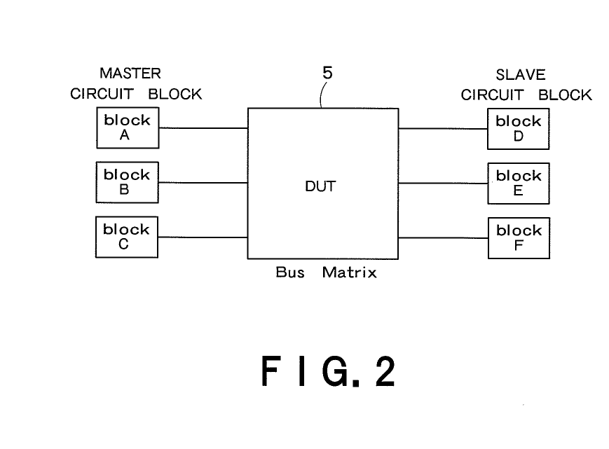

FIG. 2 is a block diagram for explaining the DUT 5. The DUT 5 in FIG. 2 is disposed between circuit blocks A, B and C at master side and circuit blocks D, E and F at slave side. Protocols are converted between the master side and the slave side, and various signals are switched between the master side and the slave side. The present embodiment explains an example for conducting the circuit description and the function verification for the DUT 5 capable of converting protocols and switching signals. However, the verification target circuit that the present invention is applicable is not necessarily limited to the DUT 5 shown in FIG. 2.

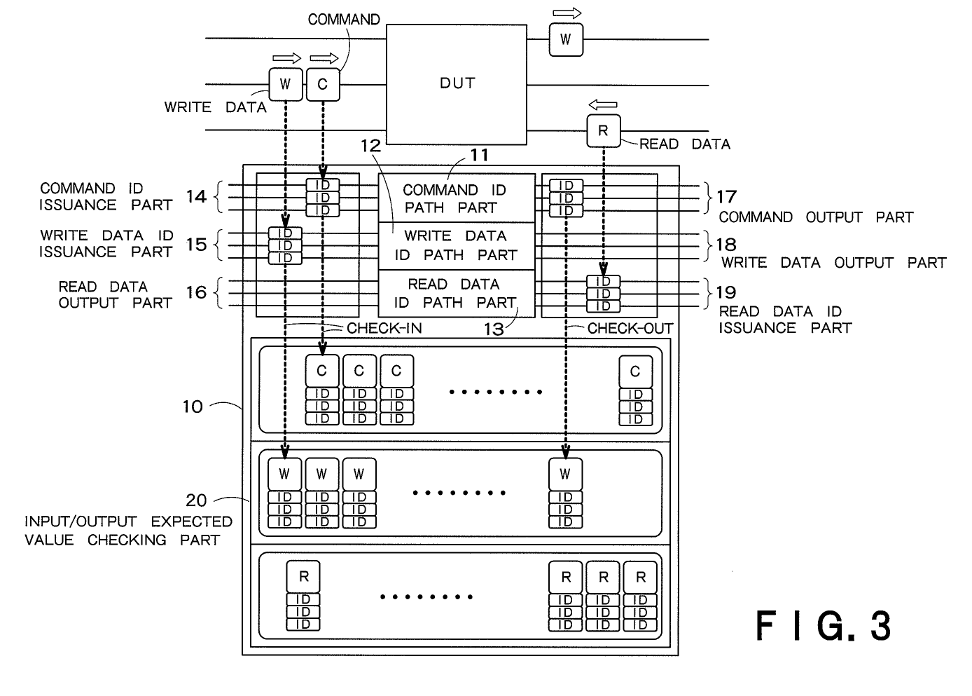

FIG. 3 is a block diagram showing characteristic constituents included in a circuit description (circuit description generator) 10 generated by the circuit description generating apparatus 1. The circuit description 10 in FIG. 3 has a command ID path part 11, a write data ID path part 12, a read data ID path part 13, a command ID issuance part 14, a write data ID issuance part 15, a read data output part 16, a command output part 17, a write data output part 18, a read data ID issuance part 19, and an input/output expected value checking part (function verification part) 20.

Here, the write data intends to data written from the master side to the slave side via the DUT 5 as shown in FIG. 2, but not data written to the DUT 5. The DUT 5 controls a destination of the write data based on the commands. In the same way, read data intends to that the master side reads out data from the slave side via the DUT 5. The DUT 5 controls a destination for reading out data based on the commands.

The command for data writing and the corresponding write data are inputted to the DUT 5 and also inputted to the command ID issuance part 14, the write data ID issuance part 15 and the input/output expected value checking part 20 in the circuit description 10. The command ID issuance part 14 and the write data ID issuance part 15 add a common ID to each of the command for data writing and the corresponding data. The input/output expected value checking part 20 acquires the commands for data writing and the corresponding write data as the expected value.

The command ID path part 11 traces the commands with IDs inputted to the input terminal of the DUT 5 along signal paths inside of the DUT 5. If necessary, the command ID path part 11 adjusts bit width of the IDs. In the same way, the write data ID path part 12 traces the write data with IDs inputted to the input terminal of the DUT 5 along signal paths inside of the DUT 5. If necessary, the write data ID path part 12 adjusts bit width of the IDs. Processing operations of these ID path parts (bit width adjusting part) 11 and 12 will be described below.

The read data transmitted from the slave side is inputted to the read data ID issuance part 19 and the input/output expected value checking part 20. The command ID issuance part 14 and the read data ID issuance part 19 add a common ID to each of the command for data reading and the corresponding read data. The input/output expected value checking part 20 acquires the command for data reading and the corresponding read data as the expected value.

The read data ID path part 13 traces the read data with IDs along the signal paths inside of the DUT 5, and if necessary, adjusts bit width of the IDs.

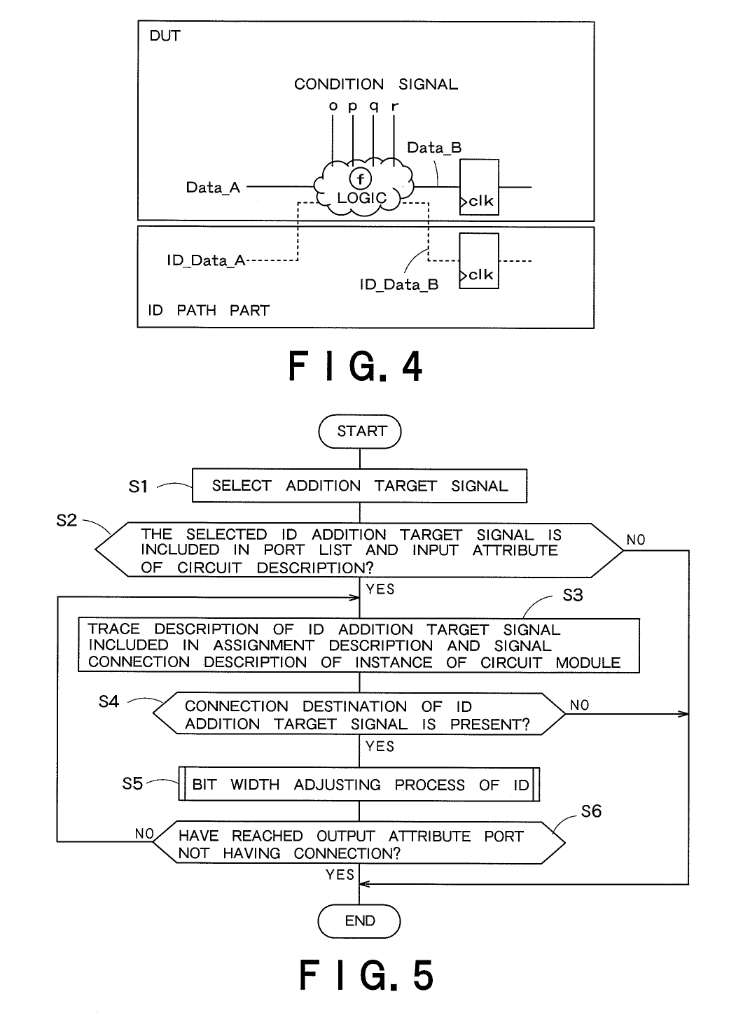

FIG. 4 is a diagram schematically explaining a relationship between the command ID path part 11, the write ID path part 12, the read data ID path part 13 and the DUT 5. Hereinafter, the command ID path part 11, the write ID path part 12 and the read data ID path part 13 are collectively called as ID path parts. As shown in FIG. 4, the above three ID path parts 11 to 13 trace the commands with IDs and the data with IDs along the signal paths inside of the DUT 5, respectively so that information of the IDs is not lost even if the signal path is branched into a plurality of signal paths or the signal paths are consolidated into one signal. More specifically, the ID path parts 11 to 13 adjust bit widths of the IDs in accordance with the signal paths of commands and data in the DUT 5 so that an association (correspondence) between the IDs of commands and the IDs of data is not lost.

One characteristic feature of the present embodiment lies in processing procedures of the ID path parts 11 to 13. FIG. 5 is a flowchart showing one example of the processing procedure of the ID path parts 11 to 13. First of all, a target signal for adding ID is selected among the input/output signals of the DUT 5 (step S1). When each signal has “VALID” information, the target signal is selected among the signals that the “VALID” information is valid.

Next, it is determined whether the selected target signal is included in a port list and an input attribute for the circuit description (step S2). If not included, the processing operations will be finished.

If it is determined to be “YES” in step S2, the circuit description corresponding to the DUT 5, more specifically, description relating to the target signal included in an assignment description and a signal connection description of an instance corresponding to a circuit module is traced in sequence (step S3).

As a result of step S3, it is determined whether a connection destination of the target signal for adding the ID is present (step S4). If the connection destination is not present, the processing operation is finished. If the connection destination is present, the below described bit width adjusting process for the ID is conducted (step S5).

Subsequently, as a result of tracing the assignment description and the signal connection description of the instance, it is determined whether or not to have reached an output attribute port which does not have any connection. If not yet reached, the process of step S3 is again conducted. If reached, the processing operation is finished.

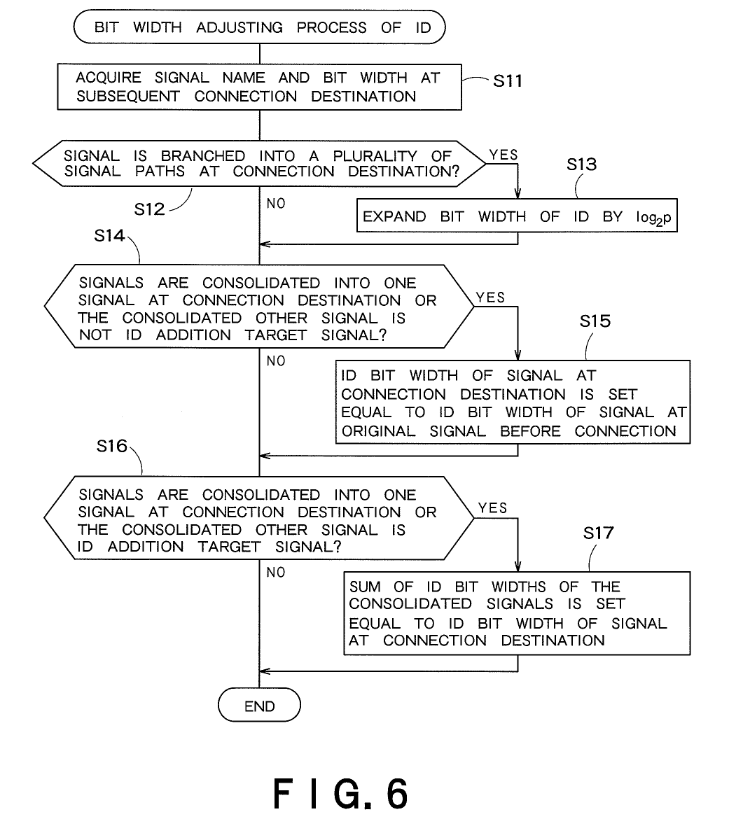

FIG. 6 is a flowchart showing one example of detailed processing procedure of the bit width adjusting process of step S5 in FIG. 5. First of all, inside of the DUT 5 is traced in sequence, and a signal name and a bit width are acquired at a subsequent connection destination (step S11).

Subsequently, it is determined whether a signal is branched into a plurality of signal paths at connection destination (step S12). When branched, log₂ p is calculated, where p is an integer of 1 or more expressing the branched number, in order to expand bit width of the ID by the calculated number (step S13).

For example, when branched into four signal paths at the connection destination, the bit width of the ID is expanded by log₂ 4=2. In this case, the bit width is expressed by the following equation (1).

{wData_A, wData_B, wData_C, wData_D}<=#D wData (1)

The “#D” in right side of equation (1) expresses a delay. The right side expresses that after the delay D, the “wData” is substituted. The right side of equation (1) expresses a signal to be connected, and the four signals at the left side of equation (1) are branched signals at destinations of connection. The IDs of the respective branched signals are expressed by the following equations (2) to (5).

wData_A_ID={wData_ID, 2′b00} (2)

wData_B_ID={wData_ID, 2′b01} (3)

wData_C_ID={wData_ID, 2′b10} (4)

wData_D_ID={wData_ID, 2′b11} (5)

When step S12 is NO, or when the process of step S13 is finished, it is determined whether a plurality of signals are consolidated into one signal at connection destination, and the consolidated other signal is not the target signal for adding the ID (step S14). When step S14 is YES, the bit width of the ID of the signal at the connection destination is set to the same bit width as that of an original signal before connection.

In the step S15, for example, when two signals are consolidated at connection destination, and one signal “wData” before connection is a target for adding the ID, while the other signal “wDataEn” is not a target for adding the ID, the following equation (6) is established.

wData_Plus<=#D{wData, wDataEn} (6)

In the equation (6), when the “wData” is 32 bits and the “wDataEn” is 4 bits, [35:4] of the signal “wData_Plus” at connection destination becomes a target bit range for adding the ID.

When step S14 is NO, it is determined whether a plurality of signals are consolidated into one signal at connection destination, and the other signal to be consolidated is also the target signal for adding the ID (step S16). When step S16 is YES, a sum of bit widths of the IDs of the consolidated respective signals is set as the bit width of the ID of the signal at connection destination (step S17).

In step S17, for example, two signals are consolidated into one signal at connection destination. When both signals are target signals for adding the IDs, the following equation (7) is established.

wData_AB<=#D{wData_A, wData_B} (7)

Here, when the ID of the signal “wData_A is “wData_A_ID” and the ID of the signal “wData_B” is “wData_B_ID”, the ID at connection destination is expressed by the following equation (8).

wData_AB_ID<={wData_A_ID, wData_B_ID} (8)

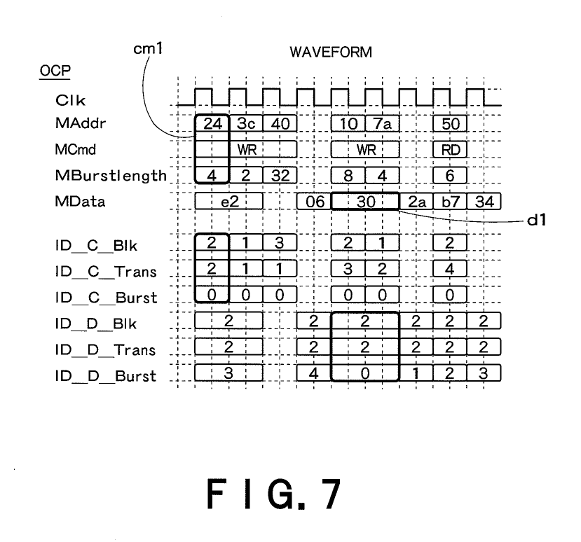

FIG. 7 is a waveform chart showing one example of a result processed by the circuit description generating apparatus 1. FIG. 7 illustrates waveform timings of OCP (Open Core Protocol). In the OCP, commands (addresses) and data are transmitted at different timings. Because of this, when commands and data are given to the DUT 5 to conduct the function verification, association between commands and data may be unable to be grasped correctly. In the case of the present embodiment, however, a value of “ID1” corresponding to the command cm1 and a value of “ID2” corresponding to the data d1 are “220”, and therefore it is possible to correctly grasp that both has the association.

FIG. 7 illustrates an example including three types of ID information, i.e. a block ID, a transaction ID and a burst ID. The block ID has an ID number unique to each circuit block (module) included in the DUT 5. The transaction ID has an ID number indicative of issuance sequence of commands issued by each circuit block. The burst ID has an ID number indicative of data transmitted by one command.

In FIG. 7, three types of ID information corresponding to IDs of commands are “ID_C_Blk”, “ID_C_Trans” and “ID_C_Burst”, respectively, and three types of ID information corresponding to IDs of data are “ID_D_Blk”, “ID_D_Trans” and “ID_D_Burst”, respectively.

In FIG. 7, the address of the command is “Maddr”, the type of the command is “MCmd”, the number of data corresponding to the command is “MBurstlength”, and data corresponding to the command is “MData”.

As illustrated in FIG. 7, it is only an example that the ID is separated into three types of ID information. The present invention is also applicable to the ID having data structure except for FIG. 7.

As shown in FIG. 3, the circuit description 10 has the input/output expected value checking part 20. The input/output expected value checking part 20 sets commands and data inputted to the DUT 5 as the expected value, or sets commands and read data to be read out as the expected value. Furthermore, the input/output expected value checking part 20 compares the expected value with a measured value indicative of a result of conducting simulation or emulation based on the circuit description 10 generated by the circuit description generating apparatus 1.

More specifically, the input/output expected checking part 20 conducts input/output checking of the commands and data and comparative checking with the expected value.

The input/output checking confirms whether commands and data are outputted via the ID path parts 11 to 13. In other word, when there is any trouble to the circuit description 10 generated by the circuit description generating apparatus 1 and no command and data have been outputted from the ID path parts 11 to 13, the input/output checking is treated as error.

Furthermore, the comparative checking with the expected value confirms whether the measured value outputted from the circuit description 10 coincides with the expected value when commands and data are given to the circuit description 10 generated by the circuit description generating apparatus 1. By conducting the comparative checking, it is possible to conduct the function verification of the DUT 5.

As described above, the input/output signal of the DUT 5 is set as the expected value, and the output signals of the ID path parts 11 to 13 is set as measured values. By comparing the expected value with the measured values, it is possible to conduct the function verification of the DUT 5 at simplified procedure.

It would never be inevitable to provide the input/output expected value checking part 20 inside of the circuit description generating apparatus 1. The input/output expected value checking part 20 may be omitted. If omitted, it is possible to simplify internal configuration of the circuit description generating apparatus 1.

As described above, according to the present embodiment, when a transmission timing between commands (addresses) and data is not the same, a common ID is allocated to the corresponding command and data, and even if the signals expressing commands and data are branched or consolidated when the signals pass through the DUT 5, the bit width of the ID is variably controlled in accordance with the branch or consolidation. Therefore, it is possible to accurately trace commands and data inside of the DUT 5, thereby improving traceability of each signal.

Furthermore, according to the present embodiment, even when transmission timings of commands (addresses) and data are the same, it is possible to determine the block number (ID_C_Blk, ID_D_Blk) and the transaction number (ID_C_Trans, ID_D_Trans), thereby conducting the comparative checking with the expected value.

Moreover, according to the present invention, three types of ID path parts are provided in the circuit description so that the ID information is not lost even if the signals expressing the commands and data are branched or consolidated when the signal passes through the DUT 5. By using the three types of ID path parts, it is possible to easily and accurately conduct a checking of whether the input/output signal of the DUT 5 passes correctly and a checking of whether the input/output signal of the DUT 5 coincides with the expected value.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

At least a portion of functions performed by the above-mentioned circuit function verification system may be constituted by at least one of hardware and software. When constituted by software, a program of executing at least a portion of the functions performed by the circuit function verification system is stored in a recording media such as a floppy disk or CD-ROM, and is loaded to a computer to execute its program. The recording media is not limited to a portable media such a magnetic disk or an optical disk, but a fixed recording media such as a hard disk drive or a memory may be used to store the program.

The program of executing at least a portion of the functions performed by the circuit function verification system may be distributed via a communication line such as Internet. The program may be distributed via a wired line or a wireless line such as Internet at a state of encrypting, modulating or compressing the program, or may be distributed at a state of being stored in the recording media.

1. A circuit description generating apparatus, comprising:
an ID addition module configured to add a common ID to a command to a verification target circuit described by a circuit description language and data corresponding to the command;
a bit width adjusting module configured to adjust a bit width of an ID of the command and an ID of the data along a signal path configured to pass through inside of the verification target circuit; and
a circuit description generator configured to generate a circuit description corresponding to the verification target circuit, the circuit description comprising the command and data with the IDs comprising bit widths adjusted by the bit width adjusting module.

2. The apparatus of claim 1, wherein the bit width adjusting module is configured to trace the signal path of the command and data from an input side to an output side of the verification target circuit in sequence, and the bit width adjusting module is configured to adjust the bit width of the corresponding command and data in accordance with the number of branched signal paths when the signal path is branched into a plurality of signal paths at a subsequent signal connection destination.

3. The apparatus of claim 2, wherein the bit width adjusting module is configured to trace the signal path of the command and data from the input side to the output side of the verification target circuit in sequence, and the bit width adjusting module is configured to expand the bit width by log₂ p, where the p is an integer of 1 or more expressing the branched number when the signal path is branched into a plurality of signal paths at the subsequent signal connection destination.

4. The apparatus of claim 1, wherein the bit width adjusting module is configured to trace the signal path of the command and data from an input side to an output side of the verification target circuit in sequence, and the bit width adjusting module is configured to determine the bit width of the ID at a subsequent signal connection destination based on the bit width of the ID of the corresponding command and data when a plurality of signal paths are consolidated at the subsequent signal connection destination and the other signal path to be consolidated is not a target signal for adding the ID.

5. The apparatus of claim 1, wherein the bit width adjusting module is configured to trace the signal path of the command and data from an input side to an outside side of the verification target circuit, and when a plurality of signal paths are consolidated at the subsequent signal connection destination and the other signal path to be consolidated is a target signal for adding the ID, the bit width adjusting module is configured to determine the bit width of the ID at the subsequent signal connection destination based on the bit widths of the IDs of the respective signal paths to be consolidated.

6. The apparatus of claim 5, wherein the bit width adjusting module is configured to trace the signal path of the command and data from an input side to an output side of the verification target circuit, and the bit width adjusting module is configured to set a sum of the bit widths of signal paths to be consolidated as a bit width of the ID at the subsequent signal connection destination when the plurality of signal paths are consolidated at the subsequent signal connection destination and the other signal path to be consolidated is a target signal for adding the ID.

7. The apparatus of claim 1, wherein the bit width adjusting module is configured to adjust the bit width of the ID preventing loss of the ID even if at least one of a branch of the signal path or a consolidation of a plurality of signal paths is conducted inside of the verification target circuit.

8. The apparatus of claim 1, further comprising a function verification module configured to verify a function of the verification target circuit by comparing a result of simulation or emulation by using the circuit description generated by the circuit description generator with an expected value corresponding to the command and data with the IDs comprising the bit widths adjusted by the bit width adjusting module.

9. The apparatus of claim 1, wherein the bit width adjusting module is configured to adjust the bit width of the corresponding ID when the command and data with the IDs are in a port list and an input attribute of the circuit description.

10. The apparatus of claim 1, wherein the bit width adjusting module is configured to adjust the bit width of the IDs of the command and data along the signal path passing through inside of the verification target circuit and to stop adjusting the bit width when the adjustment reaches an output attribute port without any connection.

11. A function verification method, comprising:
adding a common ID to a command to a verification target circuit described by a circuit description language and data corresponding to the command;
adjusting a bit width of an ID of the command and an ID of the data along a signal path passing through inside of the verification target circuit; and
generating a circuit description corresponding to the verification target circuit, the circuit description comprising the command and data with the IDs comprising adjusted bit widths.

12. The method of claim 11, further comprising:
tracing the signal path of the command and data from an input side to an output side of the verification target circuit in sequence; and
adjusting the bit width of the corresponding command and data in accordance with the number of branched signal paths, and when the signal path is branched into a plurality of signal paths at a subsequent signal connection destination.

13. The method of claim 12, further comprising:
tracing the signal path of the command and data from the input side to the output side of the verification target circuit in sequence; and
expanding the bit width by log₂ p, where the p is an integer of 1 or more expressing the branched number when the signal path is branched into the plurality of signal paths at the subsequent signal connection destination.

14. The method of claim 11, further comprising:
tracing the signal path of the command and data from an input side to an output side of the verification target circuit in sequence; and
determining the bit width of the ID at a subsequent signal connection destination based on the bit width of the ID of the corresponding command and data when a plurality of signal paths are consolidated at the subsequent signal connection destination and the other signal path to be consolidated is not a target signal for adding the ID.

15. The method of claim 11, further comprising:
tracing the signal path of the command and data from an input side to an outside side of the verification target circuit; and
determining the bit width of the ID at a subsequent signal connection destination based on the bit widths of the IDs of the respective signal paths to be consolidated when a plurality of signal paths are consolidated at the subsequent signal connection destination and the other signal path to be consolidated is a target signal for adding the ID.

16. The method of claim 15, comprising:
tracing the signal path of the command and data from the input side to the output side of the verification target circuit; and
setting a sum of the bit widths of the respective signal paths to be consolidated as a bit width of the ID at the subsequent signal connection destination when a plurality of signal paths are consolidated at the subsequent signal connection destination and the other signal path to be consolidated is a target signal for adding the ID.

17. The method of claim 11, further comprising:
adjusting the bit width of the ID to prevent the loss of the ID even if at least one of a branch of the signal path or a consolidation of a plurality of signal paths is conducted inside of the verification target circuit.

18. The method of claim 11, further comprising:
verifying a function of the verification target circuit by comparing a result of simulation or emulation by using the generated circuit description with an expected value corresponding to the command and data with the IDs comprising the adjusted bit widths.

19. The method of claim 11, further comprising:
adjusting the bit width of the corresponding ID when the command and data with the IDs are in a port list and an input attribute of the circuit description.

20. The method of claim 11, further comprising:
adjusting the bit width of the IDs of the command and data along the signal path passing through inside of the verification target circuit; and
stopping adjusting the bit width when the adjusting reaches an output attribute port without any connection.
